(19) United States
(12) Patent Application Publication
(10) Pub. No.: US 2010/0087079 A1
(43) Pub. Date: Apr. 8, 2010

(54) COMPOSITION, METHOD OF MAKING THE SAME, AND USE THEREFOR

(76) Inventors: Eumi Pyun, Ausin, TX (US); Lisa S. Lim, Sandy, UT (US); Haohao Lin, Austin, TX (US); William V. Dower, Austin, TX (US); Sidney J. Berglund, Round Rock, TX (US)

Correspondence Address: 3M INNOVATIVE PROPERTIES COMPANY, PO BOX 33427, ST. PAUL, MN, 55133-3427, US

(21) Appl. No.: 12/573,197

(22) Filed: Oct. 5, 2009

Related U.S. Application Data
(60) Provisional application No. 61/103,288, filed on Oct. 7, 2008.

(51) Int. Cl. H01R 13/52; C08K 5/53

(52) U.S. Cl. 439/271; 524/133

(57) ABSTRACT

A composition includes in relative proportion: 60 to 94 parts by weight of mineral oil; 1 to 30 parts by weight of at least one thermoplastic elastomer; and 5 to 30 parts by weight of non-halogenated metal phosphinate, wherein the non-halogenated metal phosphinate has a decomposition temperature of at least 240° C., and wherein the composition is a gel. A method of making the composition and its use as an encapsulant are also disclosed.

### CROSS-REFERENCE TO RELATED APPLICATION

This application claims the benefit of U.S. Provisional Patent Application No. 61/103,288, filed Oct. 7, 2008, the disclosure of which is incorporated by reference herein in its entirety.

### TECHNICAL FIELD

The present disclosure broadly relates to compositions including oil, an elastomer and a flame retardant. The present disclosure also relates to methods of making the compositions, and uses of the compositions.

### BACKGROUND

Insulation-displacement connector gel (IDC gel) is used in some electrical connectors (e.g., electrical connectors used in the telecommunications industry) to provide electrical insulation and moisture resistance. This type of protection is particularly useful in subterranean installations. Among such gels, oil-based systems are common. Types of oil-based gels include silicone oil based gels and hydrocarbon oil-based gels. The gels typically include a network (e.g., a polymer network) swelled with an oil phase. Polymer networks may be covalently (e.g., in the case of thermoset polymer networks) or physically bonded (e.g., in the case of styrene-rubber-styrene triblock elastomers).

### SUMMARY

In one aspect, the present disclosure provides, a composition comprising in relative proportion: 60 to 94 parts by weight of mineral oil; 1 to 30 parts by weight of at least one thermoplastic elastomer; and 5 to 30 parts by weight of non-halogenated metal phosphinate, wherein the non-halogenated metal phosphinate has a decomposition temperature of at least 240 degrees Celsius (i.e., ° C.), and wherein the composition is a gel.

In some embodiments, the composition further comprises 0.01 to 2 parts by weight of an antioxidant. In some embodiments, the at least one thermoplastic elastomer comprises a styrenic block copolymer. In some embodiments, the at least one thermoplastic elastomer is selected from the group consisting of styrene-ethylene/butylene-styrene block copolymers, styrene-ethylene/propylene-styrene block copolymers, and combinations thereof.

In some embodiments, the at least one thermoplastic elastomer comprises at least one of a diblock copolymer or a triblock copolymer. In some of those embodiments, the at least one thermoplastic elastomer comprises at least one diblock copolymer and at least one triblock copolymer in a respective weight ratio of from 0.25 to 4.

In some embodiments, the at least one thermoplastic elastomer has an average molecular weight in a range of from 150,000 to 450,000 grams per mole; for example, the at least one thermoplastic elastomer may have an average molecular weight in a range of from 200,000 to 300,000 grams per mole. In some embodiments, the composition comprises 80 to 90 parts by weight of the mineral oil. In some embodiments, the composition comprises 4 to 8 parts by weight of the at least one thermoplastic elastomer. In some embodiments, the composition comprises 10 to 15 percent of the non-halogenated metal phosphinate. In some embodiments, the non-halogenated metal phosphinate is represented by the formula

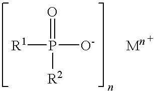

wherein each of R¹ and R² independently represents a hydrocarbyl group, M represents a metal, and n represents and integer of from 1 to 4. In some embodiments, the non-halogenated metal phosphinate comprises aluminum diethylphosphinate.

Compositions according to the present disclosure are useful; for example, as an encapsulant (e.g., a re-enterable encapsulant) for electrical connections and/or electrical circuits.

In another aspect, the present disclosure provides a method of making a composition, the method comprising combining components comprising: 60 to 94 parts by weight of mineral oil, 1 to 30 parts by weight of thermoplastic elastomer, and 5 to 30 parts by weight of a non-halogenated metal phosphinate to provide a gel.

In some embodiments, the components are combined with heating at a temperature of at least 200° C. In some embodiments, the at least one thermoplastic elastomer is selected from the group consisting of styrene-ethylene/butylene-styrene block copolymers, styrene-ethylene/propylene-styrene block copolymers, and combinations thereof.

Advantageously, compositions according to the present disclosure are typically useful as encapsulants in electrical connectors, and are capable of providing a degree of flame retardancy using relatively cheap mineral oil and thereby avoiding the need to use expensive alternatives such as, for example, silicone oils.

All numerical ranges in this application, including the specification and claims, are inclusive of their endpoints unless otherwise indicated.

In this application:

“block copolymer” means a polymer containing discrete blocks of homopolymeric segments separated by one or more homopolymeric and/or copolymeric segments;

“elastomer” means an elastic polymer;

“gel” means a semisolid viscoelastic material that can resist some mechanical stress without permanent deformation;

“hydrocarbyl group” refers to a univalent group formed by removing a hydrogen atom from a hydrocarbon;

“non-halogenated” means free of halogen atoms; and

“thermoplastic” means capable of softening or fusing when heated and of hardening again when cooled.

### DETAILED DESCRIPTION

Compositions according to the present disclosure are gels. They comprise in relative proportion: 60 to 94 parts by weight of mineral oil; 1 to 30 parts by weight of thermoplastic elastomer; and 5 to 30 parts by weight of non-halogenated metal phosphinate having a decomposition temperature of at least 240° C. That is, for every 60 to 94 parts by weight of mineral oil the composition contains 1 to 30 parts by weight of thermoplastic elastomer; and 5 to 30 parts by weight of a non-halogenated metal phosphinate having a decomposition temperature of at least 240° C.

The term mineral oil is used herein according to its ordinary usage, and refers to any of various light hydrocarbon oils, especially distillates of petroleum. Typically, the mineral oil is a white mineral oil although other mineral oils may be used. White mineral oils are generally colorless, odorless, tasteless mixtures of saturated paraffinic and naphthenic hydrocarbons that span a viscosity range of 50-370 Saybolt Universal Seconds (228 to 1680 centistokes) at 100° F. (38° C.). Nearly chemically inert, white mineral oils are essentially free of nitrogen, sulfur, oxygen and aromatic hydrocarbons. Mineral oil (60 to 94 parts by weight) is used in combination with 1 to 30 parts by weight of thermoplastic elastomer and 5 to 30 parts by weight of a non-halogenated metal phosphinate. Typically, 70 to 94 parts by weight of mineral oil, or even more typically 80 to 90 parts by weight of mineral oil are used in combination with 1 to 30 parts by weight of the at least one thermoplastic elastomer and 5 to 30 parts by weight of the non-halogenated metal phosphinate.

Thermoplastic elastomers, sometimes referred to as thermoplastic rubbers, are a class of copolymers or a physical mix of polymers (usually a plastic and a rubber) which consist of materials with both thermoplastic and elastomeric properties. Thermoplastic elastomers show both advantages typical of rubbery materials and plastic materials. Crosslinking between polymer chains in thermoplastic elastomers is typically due to a relatively weak dipole or hydrogen bond, or takes place in only in one of the phases of the material (e.g., crystallization).

There are at least six generic classes of thermoplastic elastomers available commercially. They include for example styrenic block copolymers, polyolefin blends, elastomeric alloys, thermoplastic polyurethanes, thermoplastic copolyester and thermoplastic polyamides. Examples of thermoplastic elastomers include: block copolymers such as those available under the trade designations STYROFLEX (from BASF Corp. of Parsippany, N.J.), KRATON (from Kraton Polymers, Inc. of Houston, Tex.), SEPTON (from Kuraray Co., Ltd. of Tokyo, Japan), PELLETHANE (from Dow Chemical of Midland, Mich.), PEBAX and ARNITEL (available from DSM of The Netherlands), HYTREL (from E. I. du Pont de Nemours and Co. of Wilmington, Del.); and elastomer alloys such as those available under the trade designations SANTOPRENE and GEOLAST (from Monsanto Co. of Saint Louis, Mo.) and ALCRYN (from E. I. du Pont de Nemours and Co.); and mixtures and blends thereof. Typically, the at least one thermoplastic elastomer comprises at least one block copolymer comprising one or more (e.g., at least two) polystyrene block(s) adjacent a non-crystalline polymeric segment. Examples include diblock polymers such as styrene-ethylene/propylene (SEP) block copolymers and styrene-butadiene (SB) block copolymers; triblock copolymers such as styrene-isoprene-styrene (SIS) block copolymers, styrene-butadiene-styrene (SBS) block copolymers, styrene-ethylene/butylene-styrene (SEBS) block copolymers, and styrene-ethylene/propylene-styrene (SEPS) block copolymers; tetrablock copolymers such as styrene-(ethylene-butylene)-styrene-(ethylene-butylene) (SEBSEB) block copolymers and styrene-ethylene-ethylene/propylene-styrene (SEEPS) block copolymers; and combinations of one or more of the foregoing. Examples of suitable thermoplastic elastomers include those marketed under the trade designation KRATON G series (e.g., KRATON G1650, G1650, G1652, G1654H, G1701 (including G1701E), and G1702, from Kraton Polymers, Inc.), and those marketed by Kuraray America, Inc. of Houston, Tex. under the trade designation SEPTON (SEPTON 4077).

If diblock copolymers are combined with triblock copolymers, they may be combined in a respective weight ratio of from 0.25 to 4; for example, in a respective weight ratio of from 0.25 to 0.5.

The amount of thermoplastic elastomer(s) included in the composition is in an amount of 1 to 30 parts by weight (typically 2 to 15 parts by weight, and even more typically 4 to 8 parts by weight) of thermoplastic elastomer(s) for every 60 to 94 parts by weight of mineral oil and 5 to 30 parts by weight of the non-halogenated metal phosphinate having a decomposition temperature of at least 240° C. The specific choice of thermoplastic elastomer should take into account its degree of compatibility (e.g., swellability) with mineral oil and how well it will facilitate gel formation.

The non-halogenated metal phosphinate is present in an amount of 5 to 30 parts by weight (e.g., 8 to 20 parts by weight or 10 to 15 parts by weight) for every 60 to 94 parts by weight of mineral oil and 1 to 30 parts by weight of thermoplastic elastomer. In addition to being non-halogenated, the non-halogenated metal phosphinate is relatively thermally stable (e.g., it has a decomposition temperature of at least 240° C.) which permits its use in melt compounding, in some embodiments, which may involve processing temperatures of up to 260° C., or more. The non-halogenated metal phosphinate may comprise a single compound or a mixture of non-halogenated metal phosphinates. In some embodiments, the non-halogenated metal phosphinate has a decomposition temperature of at least 260, 280, 300, 320, 340, 360, 380, or even 400° C. Advantageously, the high decomposition temperature of the non-halogenated metal phosphinate enables high temperature compounding during preparation of compositions according to the present disclosure.

In some embodiments, the non-halogenated metal phosphinate is represented by the formula

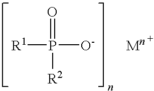

wherein each of R¹ and R² independently represents a hydrocarbyl group (e.g., an alkyl group (linear or branched and/or cyclic), an aryl group, an alkaryl group, an aralkyl group), M represents a metal (e.g., an alkali metal, alkaline earth metal, transition metal, or element from group 14 of the periodic table), and n represents and integer of from 1 to 4. Typically, R¹ and R² have from 1 to 12 carbon atoms, more typically, 1 to 6 carbon atoms. Exemplary alkyl groups represented by R¹ and R² include methyl, ethyl, n-propyl, isopropyl, n-butyl, t-butyl, n-pentyl, and n-hexyl, n-octyl, and n-dodecyl.

Examples of M in the aforementioned general formula (1) include alkali metals such as lithium, sodium, and potassium; alkaline earth metals such as magnesium, calcium, strontium, and barium; transition metals such as iron, cobalt, nickel, titanium, and zinc; and typical elements of group 14 of the periodic table such as, for example, aluminum.

One exemplary non-halogenated metal phosphinate is available as EXOLIT OP930 from Clariant Corp. of Charlotte, N.C., which is reported in paragraph [0120] of U.S. Pat. Appl. Publ. 2006/0234045 A1 (Nakanishi et al.) to be aluminum diethylphosphinate, phosphorus content=23 percent by mass. This compound typically has good heat stability and forms stable dispersions in compositions according to the present invention.

Typically, compositions according to the present disclosure comprise one or more antioxidants, but this is not a requirement. If present, the antioxidant is typically included in an amount of 1 percent or less, although more may be used. Exemplary antioxidants include: 2,6-di-t-butyl-p-cresol (BHT); benzenepropanoic acid, 3,5-bis(1,1-dimethylethyl)-4-hydroxy-, 2,2-bis((3-(3,5-bis(1,1-dimethylethyl)-4-hydroxyphenyl)-1-oxopropoxy)methyl)-1,3-propanediyl ester available as IRGANOX 1010 from Ciba Specialty Chemicals Corp. of Tarrytown, N.Y.; benzenepropanoic acid, 3,5-bis(1,1-dimethylethyl)-4-hydroxy-, octadecyl ester available as IRGANOX 1076 from Ciba Specialty Chemicals Corp.; 4,6-bis(octylthiomethyl)-o-cresol, available as IRGANOX 1520 from Ciba Specialty Chemicals Corp.; octadecyl 3-(3,5-di-t-butyl-4-hydroxyphenyl)propionate; triethylene glycol-bis-3-(3-t-butyl-4-hydroxy-5-methyl phenyl)propionate; and 1,1,3-tris(5-t-butyl-4-hydroxy-5 methyl phenyl)butane.

One or more optional additives may also be included in the composition. Examples include fillers, plasticizers, fragrances, antioxidants, and colorants.

Compositions according to the present disclosure can be made by any suitable method. In one exemplary method, the components of the composition are combined with mixing and heating to sufficient temperature to soften the thermoplastic elastomer(s). This temperature may be as high as 200° C., 220° C., 240° C., or more in some cases. After mixing is complete the composition is cooled resulting in a gel. Typically, the non-halogenated metal phosphinate is well dispersed throughout the composition, and remains dispersed for an extended period of time (e.g., for days, weeks, years), although these are not requirements.

Compositions according to the present disclosure are useful; for example, as encapsulants (e.g., IDC gel), sealing gels, and/or potting materials included in electrical connectors (e.g., telecommunications connectors), splice closures, and electrical circuits (e.g., on a printed circuit board such as a personal computer mother board). For example, the compositions may be used in conjunction with a connector available as 3M MS² SEALANT BOX 4075-S from 3M Company, of Saint Paul, Minn. For the purposes of the present disclosure, a sealing gel is a material which has a surface that can conform to provide a seal which blocks the entry of water or other environmental contamination. Sealing gels can be represented by two broad classes: soft rubbers and greases. Soft rubbers are elastic solids which embody memory and which return to shape after distortions which do not exceed their elastic limit. The softer material can have elongation to failure of over 100 percent and in some cases over 500 percent. Their adhesion to a surface is exceeded by their cohesive strength, so that if the material is touched by a finger with sufficient pressure to distort its shape and then the finger is removed from contact with the material, the material returns substantially to its original shape and the finger has essentially no transferred material on it. In contrast, a grease is a viscoelastic fluid with a yield point. When sheared beyond this yield point, it will flow and not retain a ‘memory’ of its original shape. In the case of a grease, adhesion exceeds its cohesion. Hence, touching a grease surface with a finger permanently distorts the shape of the grease, and, upon removing the finger from contact with the grease, the finger will retain a portion of the grease.

Objects and advantages of this disclosure are further illustrated by the following non-limiting examples, but the particular materials and amounts thereof recited in these examples, as well as other conditions and, details, should not be construed to unduly limit this disclosure.

### EXAMPLES

Unless otherwise noted, all parts, percentages, ratios, etc. in the Examples and the rest of the specification are by weight.

### Base Composition A

A base composition was made by extruding 89 parts KAYDOL white mineral oil (from Sonneborn Refined Products B.V., Haarlem, The Netherlands), 11.1 parts of KRATON G4609H (an SEBS block copolymer/oil blend containing 43 to 52 percent by weight percent of white mineral oil, 2 to 6 percent by weight of calcium carbonate, 0.02 top 0.06 percent by weight of antioxidant, with the remainder being a linear triblock copolymer based on styrene and ethylene/butylene and having a polystyrene content of 33 percent, from Kraton Polymers, Inc.), and 0.2 parts IRGANOX 1010 phenolic antioxidant (obtained from Ciba Specialty Chemicals, Tarrytown, N.Y.) using a Werner and Pfleiderer Model: ZSK 30 (from Krupp Werner and Pfleiderer GmbH, Stuttgart, Germany) twin-screw extruder operating at 400 rpm. The temperature profile was set as follows: zones 1=204° C., zones 2-7=249° C.

### Conductivity/Humidity Aging Test

DC electrical conductivity of each specimen was measured in a parallel plate configuration with the High Temperature Broadband Dielectric Spectrometer (0.01-10,000,000 MHz) obtained from Novocontrol Technologies GmbH & Co. KG of Hundsangen, Germany. The DC conductivity was obtained from the low frequency extrapolation by fitting the imaginary permittivity data (dielectric loss) vs. frequency to a single dielectric relaxation process acting simultaneously with the DC conduction mechanism. The maximum resolution of this electrical conductivity measurement technique is believed to be approximately 10⁻¹⁷ S/cm.

Gel specimens were aged at 93 percent relative humidity and 23° C. for one month. DC electrical conductivity of test specimens was measured three times: before the aging, after 1 week of aging, and after 1 month of aging. If in all three times, the specimens had a conductivity of less than 10⁻¹⁴ S/cm, they received a “pass” rating. Otherwise, they were rated as “fail”.

Mixing with Gel Test

Five grams of flame retardant to be evaluated were added to 45 g of a Base Composition A gel specimen to be evaluated which had been melted at 200° C., and then mixed for one minute using a SPEEDMIXER DAC 150FVZ available from FlackTek, Inc. of Landrum, S.C. operating at 3000 rpm. The appearance of the mixed sample was visually inspected after it was cooled down for uniform mixing. If uniform mixing was not observed, then the sample was rated a “fail”. The mixed sample was heated at 200° C. for 30 minutes to see whether the flame retardant would settle out from the gel. If settling was observed, then the sample was rated a “fail”. A specimen that failed either or both evaluation (s) (above) was rated as “fail”. If a specimen failed neither evaluation (above) then it was rated as “pass”.

Physical properties of various commercial flame retardants are reported in Table 1 (below), wherein “nd” means “not determined”.

TABLE 1

| FLAME | | | | | |
|---|---|---|---|---|---|
| RETARDANT | | | | | |
| TRADE | | | DECOMPOSITION | MIXING WITH | CONDUCTIVITY/ |
| DESIGNATION | TYPE | SUPPLIER | TEMPERATURE, ° C. | GEL TEST | HUMIDITY AGING |
| APYRAL | boehmite | Nabaltec AG, | 357 | pass | pass |
| AOH 180E | | Schwandorf, | | | |
| | | Germany | | | |
| BIZON | nitrogen | Firestop Chemicals | 164 | nd | nd |
| | phosphorous | Ltd., Cheshire, | | | |
| | based | United Kingdom | | | |
| BUDIT 326 | boron | Budenheim Ibérica | 100 | nd | nd |
| | phosphate | Comercial, S.A, | | | |
| | | Zaragoza, Spain | | | |
| CHEMGUARD 6 | phosphonate | Chembridge | nd | fail | nd |
| | | International Corp., | | | |
| | | Taipei, Taiwan | | | |
| CHEMGUARD 50 | phosphate | Chembridge | nd | fail | nd |
| | | International Corp. | | | |
| CLOSITE 30B | nanoclay | Southern Clay | 219 | nd | nd |
| | | Products, Inc., | | | |
| | | Gonzales, Texas | | | |
| DE83R | brominated | Chemtura Corp., | 351 | nd | nd |
| | flame retardant | Middlebury, | | | |
| | | Vermont | | | |
| FF680 | brominated | Chemtura Corp. | 288 | nd | nd |
| | flame retardant | | | | |
| FR370 | brominated | ICL Industrial | 312 | nd | nd |
| | flame retardant | Products, | | | |
| | | Beer Sheva, | | | |
| | | Israel | | | |
| FRCROS 489 | ammonium | Budenheim Ibérica | 297 | fail | nd |
| | polyphosphate | Comercial | | | |
| HIRETAR - | aromatic | Kolon Chemical | 220 | nd | nd |
| 205 | phosphinate, | Co., Kwachon, | | | |
| | 3-(hydroxyl- | Korea | | | |
| | phenyl-phosphinyl)- | | | | |
| | propanoic acid | | | | |
| EXOLIT | ammonium | Clariant AG, | 206 | nd | nd |
| IFR 23 | polyphosphate | Basel-Land, | | | |
| | based | Switzerland | | | |
| METALAST | phosphorous | Metalast | 227 | nd | nd |
| INTUMESC-2 | based | International, Inc., | | | |
| | | Minden, Nevada | | | |
| KP324 | aromatic | Kolon Chemical | 316 | fail | nd |
| | phosphinate | Co. | | | |
| EXOLIT OP930 | aliphatic metal | Clariant AG | 420 | pass | pass |
| | phosphinate | | | | |
| PE-68 | halogenated | Chemtura Corp. | 302 | nd | nd |
| | flame retardant | | | | |
| REOGARD 2000 | nitrogen | Chemtura Corp. | 292 | fail | fail |
| | phosphorous | | | | |
| | based | | | | |
| SAYTEX 8010 | brominated | Albemarle Corp., | 376 | nd | nd |
| | flame retardant | Richmond, Virginia | | | |
| TRICRESYL | aromatic | RitChem-Co., Inc., | 232 | nd | nd |
| PHOSPHATE | phosphate | Pleasantville, New | | | |
| | | York | | | |
| VERTEX 90SF | Magnesium | J M Huber Corp., | 330 | pass | pass |
| | hydroxide | Edison, New Jersey | | | |
| | (MDH) | | | | |

### Example 1

Base Composition A (90 parts) was heated at 200° C. for 30 minutes until it melted, and then it was combined with 10 parts of EXOLIT OP930 flame retardant in a bottle and well mixed. After cooling, gel was peeled off from the bottle. The resultant gel (Gel A) was cleanly removed with no residue left in the bottle, and the gel appeared homogeneous with no sign of flame retardant settling.

### Example 2

Base Composition A (95 parts) was heated at 200° C. for 30 minutes until it melted, and then it was combined with 5 parts of EXOLIT OP930 flame retardant in a bottle and well mixed. After cooling, gel was peeled off from the bottle. The resultant gel (Gel B) was cleanly removed with no residue left in the bottle, and the gel appeared homogeneous with no sign of flame retardant settling.

Base Composition A, Gel A, and Gel B, were evaluated according to the Conductivity/Humidity Aging Test, and are were all found to be below 10⁻¹⁴ Siemens/centimeter (S/cm) even after aging at 93 percent relative humidity and 23° C. for 1 month. Results are reported in Table 2 (below).

TABLE 2

| | DC CONDUCTIVITY, S/cm | | |
|---|---|---|---|
| | Before Aging | 1 week Aging | 1 month aging |
| Base | 2.20 × 10⁻¹⁶ | 3.84 × 10⁻¹⁶ | 4.61 × 10⁻¹⁶ |
| Composition A | | | |
| Gel A | 1.32 × 10⁻¹⁶ | 1.18 × 10⁻¹⁶ | 1.25 × 10⁻¹⁶ |
| Gel B | 6.51 × 10⁻¹⁶ | 6.35 × 10⁻¹⁶ | 7.75 × 10⁻¹⁶ |

Flammability of Base Composition A and Gel A was evaluated by ASTM E1354-08, Standard Test Method for Heat and Visible Smoke Release Rates for Materials and Products Using an Oxygen Consumption Calorimeter”, 2008, (cone calorimeter) and UL746C, “Polymeric Materials—Use in Electrical Equipment Evaluations”, February 2006, 20 mm flame tests. Table 3 reports results of the ASTM E1354-08 test (cone calorimeter). In Table 3, the Fire Growth Rate is not included in ASTM E1354-08. It was calculated as the peak heat release rate divided by the time to peak heat release.

TABLE 3

ASTM E1354 (cone calorimeter)
FLAMMABILITY TEST

| | PEAK HEAT | |
|---|---|---|
| | RELEASE RATE, | FIRE GROWTH |
| | kilowatts/meter² | RATE |
| Base Composition A | 3724 | 26.6 |
| Gel A | 2800 | 20 |
| | (25% reduction) | (25% reduction) |

Base Composition A, Gel A, and Gel B were used in a 3M 4500 Modular Terminating System electrical connector available from 3M Company, filled with the gel according to normal usage conditions.

Ten replicates of each gel/connector combination were tested according to the UL746C, 20 mm flame test. Base Composition A had a zero percent pass rate, while Gel B had a 20 percent pass rate, and Gel A had a 100 percent pass rate. Eighty percent of the connectors containing Base Composition A exhibited dripping, 50 percent of the connectors containing Gel B exhibited dripping, and none of the connectors containing Gel A exhibited dripping.

Various modifications and alterations of this disclosure may be made by those skilled in the art without departing from the scope and spirit of this disclosure, and it should be understood that this disclosure is not to be unduly limited to the illustrative embodiments set forth herein.

What is claimed is:

1. A composition comprising in relative proportion:
60 to 94 parts by weight of mineral oil;
1 to 30 parts by weight of at least one thermoplastic elastomer; and
5 to 30 parts by weight of non-halogenated metal phosphinate, wherein the non-halogenated metal phosphinate has a decomposition temperature of at least 240 degrees Celsius, and wherein the composition is a gel.

2. The composition of claim 1, further comprising 0.01 to 2 parts by weight of an antioxidant.

3. The composition of claim 1, wherein the at least one thermoplastic elastomer comprises a styrenic block copolymer.

4. The composition of claim 1, wherein the at least one thermoplastic elastomer is selected from the group consisting of styrene-ethylene/butylene-styrene block copolymers, styrene-ethylene/propylene-styrene block copolymers, and combinations thereof.

5. The composition of claim 1, wherein the at least one thermoplastic elastomer has an average molecular weight in a range of from 150,000 to 450,000 grams per mole.

6. The composition of claim 1, wherein the at least one thermoplastic elastomer comprises at least one of a diblock copolymer or a triblock copolymer.

7. The composition of claim 1, wherein the at least one thermoplastic elastomer comprises at least one diblock copolymer and at least one triblock copolymer in a respective weight ratio of from 0.25 to 4.

8. The composition of claim 1, wherein the composition comprises 80 to 90 parts by weight of the mineral oil.

9. Use of the composition of claim 8 as a gel encapsulant for at least one of an electrical connection or an electrical circuit.

10. The composition of claim 1, wherein the composition comprises 4 to 8 parts by weight of the at least one thermoplastic elastomer.

11. The composition of claim 1, wherein the composition comprises 10 to 15 percent of the non-halogenated metal phosphinate.

12. The composition of claim 1, wherein the non-halogenated metal phosphinate is represented by the formula 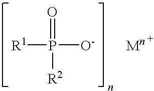
wherein each R¹ and R² independently represents a hydrocarbyl group, M represents a metal, and n represents and integer of from 1 to 4.

13. The composition of claim 1, wherein the non-halogenated metal phosphinate comprises aluminum diethylphosphinate.

14. Use of the composition of claim 13 as a gel encapsulant for at least one of an electrical connection or an electrical circuit.

15. Use of the composition of claim 1 as a gel encapsulant for at least one of an electrical connection or an electrical circuit.

16. The use claim 15, wherein the electrical circuit comprises part of a printed circuit board.

17. Use of the composition of claim 1 as a gel encapsulant in a telecommunications electrical connection block.

18. A method of making a composition, the method comprising combining components comprising: 60 to 94 parts by weight of mineral oil, 1 to 30 parts by weight of thermoplastic elastomer, and 5 to 30 parts by weight of a non-halogenated metal phosphinate to provide a gel.

19. The method of making a composition of claim 18, wherein the components are combined with heating at a temperature of at least 200 degrees Celsius.

20. The method of making a composition of claim 18, wherein the at least one thermoplastic elastomer is selected from the group consisting of styrene-ethylene/butylene-styrene block copolymers, styrene-ethylene/propylene-styrene block copolymers, and combinations thereof.
